(19) United States
(12) Patent Application Publication
(10) Pub. No.: US 2004/0199701 A1
(43) Pub. Date: Oct. 7, 2004

(54) Bus system and method for exchanging data

(76) Inventor: Robert Eckmuller, Ringelai (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/484,141

(22) PCT Filed: Jul. 2, 2002
(86) PCT No.: PCT/DE02/02405

(30) Foreign Application Priority Data
Jul. 17, 2001 (DE) 101 34 584.4

(51) Int. Cl. G06F 13/14

(52) U.S. Cl. 710/305

(57) ABSTRACT

The invention relates to a bus system comprising at least two bus lines (11; 12) whereon a differential level is applied, said level being dominant or recessive. The bus system also comprises at least two transceivers (22) for bidirectional communication in semi-duplex operation which are connected to the bus lines (11; 12) and which transform the differential levels of the bus lines into a digital level, in addition to at least one hardware-interface (231) which is connected to one of the two transceivers (22) for asynchronous, bidirectional communication in full-duplex operation. A CAN bus can be used for storing data or for carrying out a diagnosis without the need for recalling the CAN-protocol.

The invention relates to a bus system for asynchronous communication with at least two bus lines on which there is a differential level, and to a method for interchanging data on such a bus system.

Particularly in motor vehicles, CAN buses are increasingly being used for networking controllers and sensors. For diagnostic purposes (final test) or for programming the controllers connected to the bus at the end of the belt (application) or during program updates in a workshop, it is necessary to connect an external appliance to the controllers. This can be done by aligning the programs in the external diagnostic/application appliances already used to date and in the corresponding controllers with the communication in the CAN protocol. However, in addition to the expenditure which this requires, one drawback is the slow data transmission as a result of the data structure of the CAN protocol. It is therefore usual practice to use an additional, comparatively complex interface operating as a differential amplifier, such as RS422 or RS232, and additional bus lines to access the desired controller.

It is the aim of the invention to make a bus system which connects a plurality of controllers to one another accessible for an external diagnostic or application appliance in a particularly simple and efficient manner.

This aim is achieved by means of a bus system and a method for interchanging data, as defined in the independent patent claims. Advantageous embodiments of the invention are the subject matter of the subclaims.

The use of a hardware interface for asynchronous, bidirectional communication in conjunction with transceivers which convert the differential levels on the bus lines into a digital level allows simple interfaces regularly implemented in standard controllers to be used for accessing the bus system. These do not have to produce any differential gain themselves. In this case, the electromagnetic compatibility (EMC) of the differential current or voltage levels nevertheless attained on the bus lines are advantageous for the data transmission. Together with the transceiver, the hardware interface undertakes the task of an asynchronous interface.

Although one particularly preferred embodiment involves the use of inexpensive CAN transceivers, it is possible to increase the speed of data transmission to approximately 1.5 to 2 times that of the CAN protocol. When UART is used, the speed increases to approximately 1.8 times that of operation under the CAN protocol. Since a microcontroller designed for the CAN protocol usually has both a CAN controller (CAN hardware interface) and a UART hardware interface implemented in it (“embedded controller”), no additional chips are required for an access or gateway to an existing CAN bus system. The associated CAN transceiver can be used for communication both using CAN and using UART.

Further advantages, features and opportunities for application of the invention can be found in the description below of exemplary embodiments in conjunction with the drawings, in which:

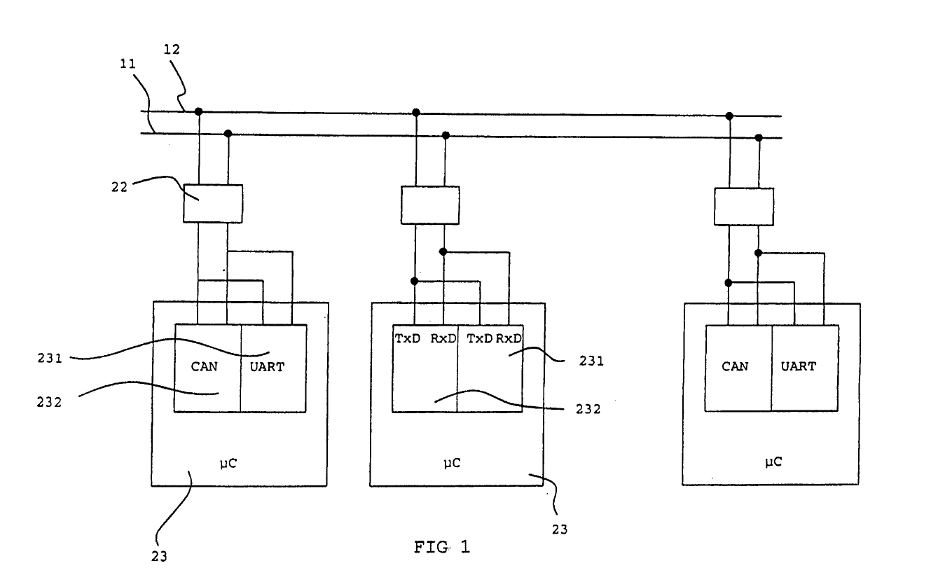

FIG. 1 shows a CAN bus having a plurality of microcontrollers connected thereto,

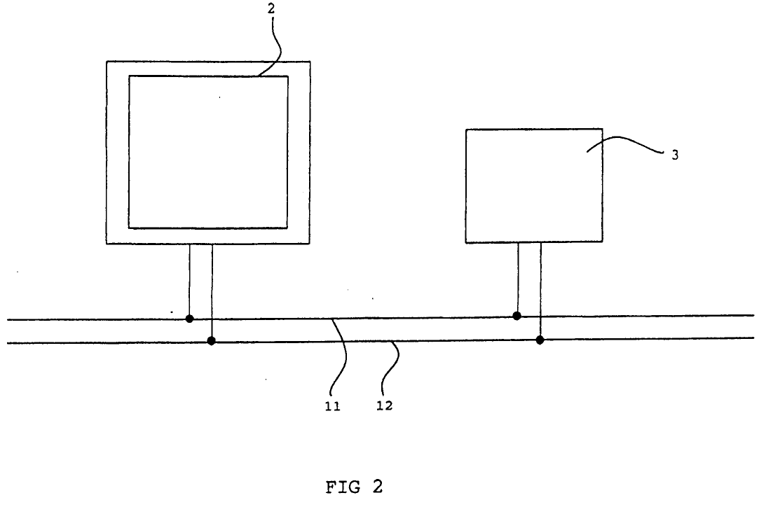

FIG. 2 shows a CAN bus having two bus users, and

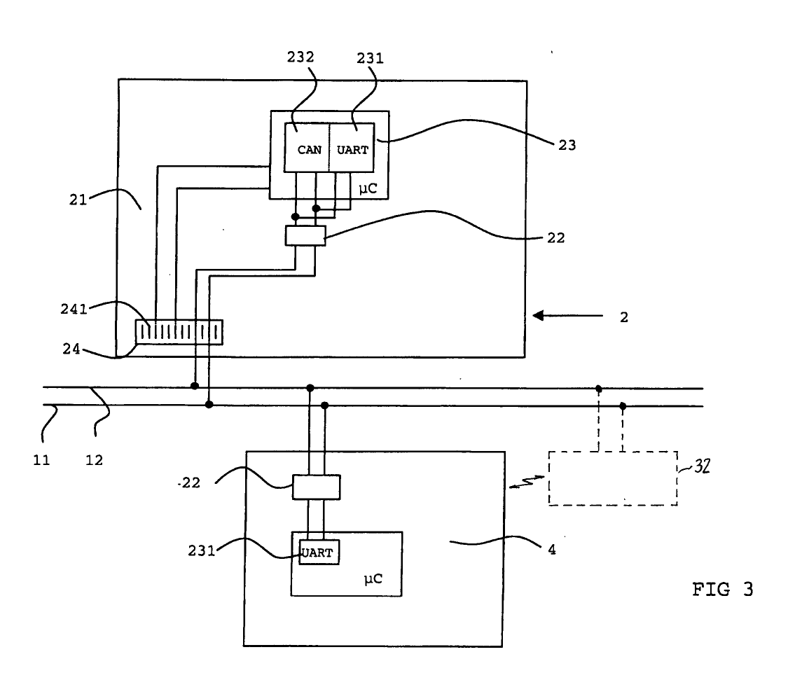

FIG. 3 shows the printed circuit board for the display device in FIG. 2.

FIG. 1 shows part of a bus system in a motor vehicle having two bus lines 11 and 12. This is a CAN bus which, in line with the CAN specifications, is operated at different voltage levels and has a dominant state and a recessive state. The recessive state establishes itself without any action by a bus user. The dominant state needs to be set by an active user. Bus line 11 transmits the signal CANL and bus line 12 transmits the signal CANH. The signal CANL can assume the voltage values 1.5 V and 2.5 V, and CANH can assume the voltage values 2.5 V and 3.5 V. In the dominant state, which corresponds to the digital value 0 or low, CANL is at 1.5 V and CANH is at 3.5 V. In a recessive state, which corresponds to the digital value 1 or high, both CANL and CANH are at 2.5 V.

The bus users can be a display which receives the data to be displayed from further bus users, for example from a temperature measurement device, from a radio, from a navigation appliance and the like.

A respective CAN transceiver 22 in a bus user connects a control unit or a microcontroller 23 to the bus lines 11, 12 and hence to other users. In one direction, the transceivers 22 convert digital signals from the microcontrollers 23 at TTL level into differential signals, and in the opposite direction they convert the differential signals on the bus lines 11, 12 into digital signals at 0 V and 5 V.

The CAN transceivers output signals produced by the associated microcontroller onto the bus lines 11, 12 and simultaneously read the output signals back to the same microcontroller. This is done on a two-wire line having the signal lines RxD and TxD.

The users associated with the microcontrollers 23, which users are controllers and sensors, have not been shown.

The microcontrollers 23 have both a UART hardware interface 231 and a CAN hardware interface or CAN controller 232 as a bus controller implemented in them (“embedded”). Each of the two interfaces has a respective electrical connection to the transceiver. The two bus controllers are thus connected in parallel.

A UART interface is basically designed for bidirectional communication in full-duplex mode (simultaneous reading and writing). However, the connection to a CAN transceiver means that the UART interfaces 231 can communicate only in half-duplex mode (either reading or writing).

When the system is started, at first the UART interface 231 is activated and the CAN controller 232 is disabled, respectively, in order to avoid simultaneous communication using different bus protocols. It is therefore immediately possible to start applying data, that is to say programming bus users, and testing/performing diagnosis for the users. In this mode, data transmission can take place at a higher transmission speed than in the case of operation on the basis of the CAN protocol.

If no signals from a UART interface are recognized within a predefined period of time, for example 5 ms, the UART interface 231 is disabled and the CAN controller 232 is activated. Signals from a UART interface can be distinguished from signals from a CAN controller on the basis of the data transmission speed (baud rate), on the basis of recognition of the CAN protocol or on the basis of parity errors. To increase the certainty of recognition, it is possible to combine a plurality of recognition methods.

FIG. 2 shows the bus system from FIG. 1 with two exemplary bus users. These are a display device 2 for a driver information system and a controller 3, to be more precise an engine controller.

A control unit (microprocessor) connected to the display device 2 receives data from the controller in order to ascertain the vehicle's fuel consumption and to output it to the vehicle driver.

FIG. 3 shows one of the microcontrollers 23 shown in FIG. 1 on a printed circuit board 21 in a bus user. The bus user is the display device 2 shown in FIG. 2.

The UART hardware interface 231 and the CAN controller 232 in the microcontroller 23 are connected to the same electric contacts 241 on a plug connector 24 via the transceiver 22. The plug connector 24 is integrated in the housing of the bus user and sets up a connection to a power supply and to the bus lines 11, 12 in the CAN bus. In addition, the plug connector can also be used to set up a direct connection—without the mediation of the CAN bus—to an external appliance, for example a telephone or an audio appliance.

The plug connector 24 can additionally be used to connect an external programming (application) or test appliance in order to store data in a user connected to the bus system or to perform a function test for a user.

In the example illustrated, the external programming appliance 4 is connected to the bus lines 11, 12 and hence to the bus user which is to be programmed by means of a separate plug connector (not shown) at a suitable location in the motor vehicle.

External appliances can also be connected using a wireless interface, for example using an infrared interface based on the IRDA standard or using a Bluetooth interface. The wireless interface can set up a connection to the CAN bus or directly to an external appliance.

1.-13. (canceled)

14. A bus system, comprising:
two bus lines for conducting a differential level, wherein said differential level selectively assumes one of a dominant state and a recessive state;
at least two transceivers connected to said two bus lines for bi-directional communication with said two bus lines in half duplex mode, each of said at least two transceivers converting the differential level on said two buses into a digital level; and
a hardware interface connected to one of said at least two transceivers, said hardware interface being capable of asynchronous, bi-directional communication in full duplex mode.

15. The bus system of claim 14, further comprising one of a plug connector and a wireless device connected to said two bus lines, wherein said hardware interface is connected to said one of a plug connector and a wireless device by said one of said at least two transceivers.

16. The bus system of claim 14, further comprising a display device having a plug connector connected to said two bus lines and a controller in a motor vehicle connected said two bus lines, wherein said bus system connects said display device to said controller, and hardware interface is connected to said plug connector by said one of said at least two transceivers.

17. The bus system of claim 14, wherein each of said at least two transceivers comprises a CAN transceiver.

18. The bus system of claim 17, wherein said hardware interface comprises a UART interface.

19. The bus system of claim 14, wherein said hardware interface comprises a UART interface.

20. The bus system of claim 14, further comprising a microcontroller having two hardware interfaces, said two hardware interfaces being connected to the same one of said at least two transceivers.

21. The bus system of claim 20, wherein one of said at least two hardware interfaces comprises a CAN controller.

22. The bus system of claim 21, wherein said CAN controller and the other of said two hardware interfaces are integrated in said microcontroller.

23. A method for interchanging data on a bus system, wherein the bus system includes two bus lines for conducting a differential level, wherein the differential level selectively assumes one of a dominant state and a recessive state, at least two transceivers connected to the two bus lines for bi-directional communication in half duplex mode, each of the at least two transceivers converting the differential level on the two buses into a digital level, and a microcontroller having first and second hardware interfaces, the first and second hardware interfaces being connected to the same one of the at least two transceivers, the first hardware interface being capable of asynchronous, bi-directional communication in full duplex mode, said method comprising the steps of:
activating one of the first and second hardware interfaces and disabling the other of the first and second hardware interfaces when the bus system is first started; and
disabling the one of the first and second hardware interfaces and activating the other of the first and second hardware interfaces if no signals from the one of the first and second hardware interfaces are recognized within a period of time.

24. The method of claim 23, wherein the first hardware interface communicates at different data transmission speed than said second hardware interface.

25. The method of claim 23, further comprising the step of distinguishing between the signals from the first and second hardware interfaces based on at least one of different data transmission speeds, parity errors, data patterns from different communication protocols used by the first and second hardware interfaces.

26. The method of claim 23, wherein the one of the first and second hardware interfaces is a UART interface and the other of the first and second hardware interfaces is a CAN controller.

27. The method of claim 26, further comprising the step of distinguishing between the signals from the first and second hardware interfaces based on different data patterns.
